(19) United States
(12) Patent Application Publication
(10) Pub. No.: US 2026/0304145 A1
(43) Pub. Date: Oct. 1, 2026

(54) ARTIFICIAL INTELLIGENCE-DRIVEN COEXISTENCE MANAGEMENT SYSTEM FOR MULTI-PROTOCOL WIRELESS COMMUNICATIONS

(71) Applicant: Silicon Laboratories Inc., Austin, TX (US)

(72) Inventor: Wael Guibene, McKinney, TX (US)

(21) Appl. No.: 19/084,134

(22) Filed: Mar. 19, 2025

(51) Int. Cl. H04W 24/02; G06N 3/0464; H04L 27/26; H04W 72/1263

(52) U.S. Cl. CPC H04W 24/02; G06N 3/0464; H04L 27/2678; H04W 72/1263

(57) ABSTRACT

In one embodiment, an apparatus includes: a wireless transceiver to communicate radio frequency (RF) signals of a plurality of wireless protocols; a signal identifier circuit coupled to the wireless transceiver; and a coexistence management controller coupled to the signal identifier circuit. The signal identifier circuit may identify a presence of signaling of at least one wireless protocol in the incoming RF signals, using at least one first artificial intelligence (AI) model. The coexistence management controller may predict, based at least in part on the presence of signaling, interference in the portion of the radio spectrum using at least one second AI model.

### BACKGROUND

The increasing number of devices operating in the 2.4 gigahertz (GHz) Industrial, Scientific, and Medical (ISM) band, including those using Zigbee, Thread, Bluetooth Low Energy (BLE), and Wi-Fi protocols, has led to significant challenges in managing spectrum coexistence. Traditional coexistence mechanisms rely on static algorithms and predefined rules that are insufficient in adapting to dynamic interference patterns and varying network conditions.

### SUMMARY OF THE INVENTION

In one aspect, an apparatus includes: a wireless transceiver to communicate radio frequency (RF) signals of a plurality of wireless protocols; a signal identifier circuit coupled to the wireless transceiver; and a coexistence management controller coupled to the signal identifier circuit. The signal identifier circuit may be configured to: collect signal data from incoming RF signals of a portion of a radio spectrum received via the wireless transceiver; extract a plurality of features from the signal data; and identify a presence of signaling of at least one wireless protocol in the incoming RF signals, based at least in part on the plurality of features, using at least one first artificial intelligence (AI) model. The coexistence management controller may be configured to: predict, based at least in part on the presence of signaling, interference in the portion of the radio spectrum using at least one second AI model; and dynamically allocate spectrum resources of the portion of the radio spectrum, based at least in part on the interference prediction.

In one implementation, the coexistence management controller comprises a scheduler to generate scheduling information according to the dynamically allocated spectrum resources, the scheduling information to identify one or more wireless protocols to be active during a scheduling interval. The scheduler may be configured to issue at least one grant signal for the one or more wireless protocols to a media access control layer of the wireless transceiver to cause the one or more wireless protocols to be active during the scheduling interval. The apparatus may also include a feedback circuit to receive feedback information regarding performance of the one or more wireless protocols, and to update the at least one second AI model based at least in part on the feedback information.

In an implementation, the at least one first AI model may include at least one of a convolutional neural network (CNN) or a recurrent neural network (RNN), and the at least one second AI model may be a reinforcement learning algorithm. The signal identifier circuit may be configured to identify the presence of signaling comprising a probability distribution regarding a plurality of wireless protocols that operate at the portion of the radio spectrum comprising a common portion of the radio spectrum. The coexistence management controller may predict the interference based at least in part on the probability distribution, the probability distribution comprising a plurality of probability values, each associated with one of the plurality of wireless protocols.

In an implementation, the signal identifier circuit is to extract the plurality of features using at least one of a Fast Fourier Transform, a Wavelet Transform, or a cyclostationary analysis. The signal identifier circuit may: generate at least one feature vector based at least in part on the plurality of features extracted using at least two of the Fast Fourier Transform, the Wavelet Transform, or the cyclostationary analysis; and provide the at least one feature vector to the at least one first AI model to identify the presence of signaling.

In one implementation, the coexistence management controller is to dynamically allocate the spectrum resources of the portion of the radio spectrum further based at least in part on priority information associated with one or more of the plurality of wireless protocols. The apparatus may be a system on chip including: the wireless transceiver; at least one host processor to execute instructions; and at least one neural processor to run the at least one first AI model and the at least one second AI model.

In another aspect, a method includes: receiving, in a wireless transceiver of a wireless device, incoming RF signals of a plurality of wireless protocols, the plurality of wireless protocols to communicate in a common band; extracting a feature set from the incoming RF signals using a plurality of feature extraction techniques; classifying, in the wireless device, the incoming RF signals, based at least in part on the feature set, using at least one first AI model, to determine a probability distribution regarding the plurality of wireless protocols; predicting an interference scenario based at least in part on the probability distribution, using at least one second AI model; and dynamically allocating the common band to at least one of the plurality of wireless protocols based at least in part on the interference scenario.

In one implementation, dynamically allocating the common band to the at least one of the plurality of wireless protocols comprises scheduling a first wireless protocol to operate on the wireless transceiver for a first time duration of an interval and scheduling a second wireless protocol to operate on the wireless transceiver for a second time duration of the interval, the first time duration longer than the second time duration. The method further includes scheduling the first wireless protocol and the second wireless protocol further based at least in part on a first priority associated with the first wireless protocol and a second priority associated with the second wireless protocol, the first priority higher than the second priority. The method further comprises in response to a change in at least the second priority, scheduling the second wireless protocol to operate for a third time duration, the third time duration longer than the second time duration. The method may also include classifying the incoming RF signals on at least one neural processor of the wireless device, using the at least one first AI model.

In yet another aspect, a method includes: receiving, in at least one processor of a wireless transceiver, class probability information comprising a probability distribution regarding activity of a plurality of wireless protocols in a common band of a radio spectrum; predicting an interference scenario based at least in part on the class probability information using at least one AI model; and dynamically allocating the common band to at least one of the plurality of wireless protocols based at least in part on the interference scenario.

Dynamically allocating the common band to the at least one of the plurality of wireless protocols includes scheduling a first wireless protocol to operate on the wireless transceiver for a first time duration of an interval and scheduling a second wireless protocol to operate on the wireless transceiver for a second time duration of the interval, the first time duration different than the second time duration.

The method may also include scheduling the first wireless protocol for the first time duration and scheduling the second wireless protocol for the second time duration further based at least in part on a first priority of the first wireless protocol and a second priority of the second wireless protocol. The method may also include: receiving feedback information regarding performance of the first wireless protocol and the second wireless protocol; and updating the at least one AI model based at least in part on the feedback information.

In one example, a computer-readable storage medium includes instructions to perform the methods described above. In another example, a computer-readable storage medium including data is to be used by at least one machine to fabricate at least one integrated circuit to perform the methods described above. In yet another example, an apparatus comprises means for performing the methods described above.

### BRIEF DESCRIPTION OF THE DRAWINGS

FIG. 1 is a block diagram of a wireless transceiver system on chip in accordance with an embodiment.

FIG. 2 is a flow diagram of a method in accordance with an embodiment.

FIG. 3 is a flow diagram of a method in accordance with another embodiment.

FIG. 4 is a flow diagram of a method in accordance with yet another embodiment.

FIG. 5 is a block diagram of a representative integrated circuit in accordance with an embodiment.

FIG. 6 is a high-level diagram of a network in accordance with an embodiment.

### DETAILED DESCRIPTION

In various embodiments, a wireless communication system is provided with intelligent coexistence management control techniques to reduce contention among multiple wireless protocols operating within a common frequency spectrum. In embodiments, machine learning (ML) and/or artificial intelligence (AI) techniques may be used to enhance signal identification, interference prediction, and dynamic spectrum allocation in the common frequency spectrum.

A coexistence management system in accordance with an embodiment employs advanced signal processing, AI/ML algorithms, and real-time analytics to optimize the operation of multiple wireless protocols within a common frequency spectrum. As used herein, the terms “AI/ML,” “AI” and “ML” are used collectively to refer to one or both of AI and ML, where ML can be considered to be a particular subset or form of AI. For purposes of discussion, embodiments will focus on the 2.4 GHz ISM spectrum to ensure efficient and reliable communication across diverse protocols such as Zigbee, Thread, Bluetooth Low Energy (BLE), and Wi-Fi. Of course, the systems and techniques described herein can be used at any frequency. In some embodiments, a high-performance wireless system on chip (SoC) may be configured with one or more AI/ML hardware accelerators or other hardware circuitry to accurately identify and classify incoming radio frequency (RF) signals, predict potential interference, and dynamically allocate spectrum resources by optimizing grant signaling, based at least in part on real-time analysis and predictive modeling. In this way, transmission retries may be reduced, collisions minimized, and network reliability and efficiency may increase.

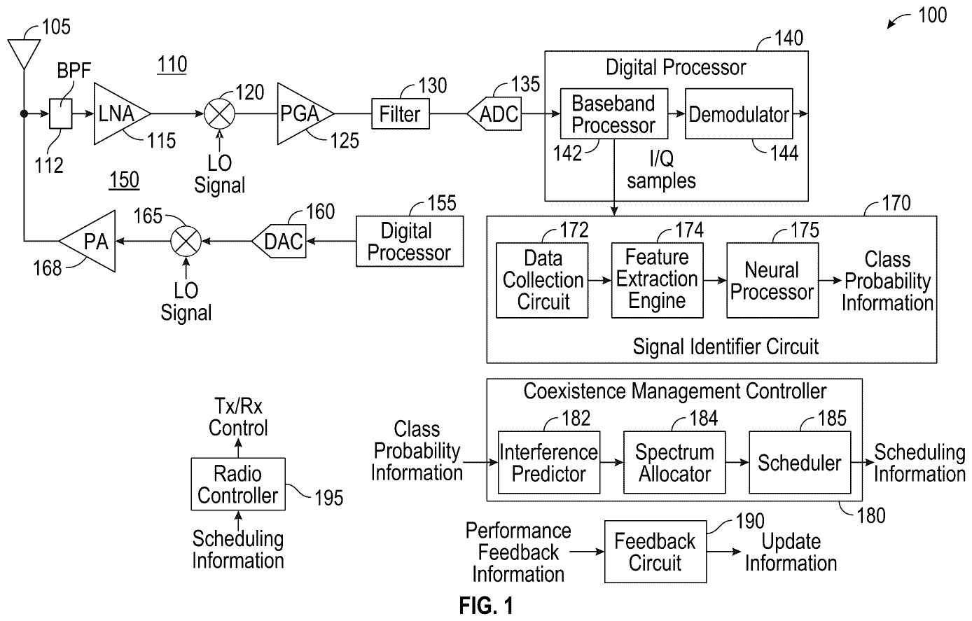

Referring now to FIG. 1, shown is a block diagram of a wireless transceiver SoC in accordance with an embodiment. As shown in FIG. 1, SoC 100, which may be implemented on a single semiconductor die and integrated into an integrated circuit (IC), includes various circuitry that couples to an external antenna 105. In the high-level view shown in FIG. 1, the transceiver of SoC 100 includes a receive signal processing path 110 and a transmit signal processing path 150. In the embodiment of FIG. 1, the wireless transceiver may be configured to support multiple wireless protocols, including IEEE 802.15.4 (Zigbee, Thread), Bluetooth 5.2 (BLE), and IEEE 802.11 (Wi-Fi), among others. Additionally, various digital circuitry is included in FIG. 1, as will be discussed further below.

Beginning first with receive signal processing path 110, incoming radio frequency (RF) signals received via antenna 105 are provided to a bandpass filter (BPF) 112, which performs bandpass filtering. For example, in embodiments described herein in which multiple protocols operate in a common portion of a radio spectrum, BPF 112 may be configured to pass signals of a given band. For purposes of discussion herein, BPF 112 may be configured to isolate the 2.4 GHz ISM band, e.g., using Finite Impulse Response (FIR) or Infinite Impulse Response (IIR) filters with specific cutoff frequencies

In turn, the filtered RF signals are provided to a low noise amplifier (LNA) 115, which amplifies the incoming RF signals. The amplified RF signals are provided to a mixer 120, which operates to downconvert the RF signals to a lower frequency, e.g., a given intermediate frequency (IF). Although not shown in the high level in FIG. 1, understand that mixer 120 may be a complex mixer in implementations in which receiver signal processing path has in-phase (I) and quadrature phase (Q) paths for separately processing I and Q signals.

The lower frequency signals output from mixer 120 are provided to a programmable gain amplifier (PGA) 125 for further gain processing, and are further filtered in a filter 130. After filtering, the signals are digitized in an analog-to-digital converter (ADC) 135. The resulting digital signals are provided to a digital processor 140. In various implementations, digital processor 140 may be a digital signal processor (DSP) or other processing core. As illustrated, digital processor 140 includes a baseband processor 142 to perform digital processing of the signals. In turn, the processed signals are provided to a demodulator 144 which generates demodulated symbols that can be provided for further processing in additional digital processing circuitry (not shown for ease of illustration in FIG. 1). As further shown, I/Q samples generated in baseband processor 142 are further provided to a signal identifier circuit 170, details of which are further described below.

Still with reference to FIG. 1, transmit signal processing path 150 includes a digital processor 155 which processes message data to be transmitted. The resulting digital signals, e.g., modulated symbols, in turn are provided to a digital-to-analog converter (DAC) 160 for conversion to analog signals. These analog signals are provided to a mixer 165, which upconverts the analog signals to RF level. Although shown at this high level in FIG. 1, understand that mixer 165 may be implemented as a complex mixer. The resulting RF signals in turn are provided to a power amplifier (PA) 168 for amplification and then output via antenna 105.

As described above, in embodiments, interference between RF signals of different wireless protocols operating at a common band can be monitored. Based at least in part on identification of incoming signals of different wireless protocols within the band, interference can be predicted. Then, based at least in part on this interference prediction, intelligent coexistence management may be performed to dynamically allocate the limited spectrum resources to the different active wireless protocols.

To this end, SoC 100 includes signal identifier circuit 170. As described above, signal identifier circuit 170 receives incoming I/Q samples from receiver signal processing path 110. These samples are provided to a data collection circuit 172. Data collection circuit 172 may be configured to capture raw I/Q signal samples, and may support sampling rates up to 20 Mega Samples Per Second (MSPS) for high-resolution signal analysis. The resulting collected data are passed to a feature extraction engine 174, which may perform various algorithms to extract features from the collected data. Feature extraction engine 174 may be configured to implement algorithms such as Fast Fourier Transform (FFT), Wavelet Transform, and cyclostationary analysis, to extract features like signal bandwidth, modulation type, symbol rate, and higher-order statistics such as kurtosis, skewness, and cumulants. In some embodiments, feature extraction engine 174 may be configured to generate feature vectors that in turn are provided to a neural processor 175.

Neural processor 175 is configured to run one or more AI/ML models based on this input of feature vectors to generate class probability information. In an embodiment, such AI/ML models may include deep learning architectures, such as Convolutional Neural Networks (CNNs) and Recurrent Neural Networks (RNNs). Note that these models may be provisioned into SoC 100 during manufacture, and as will be described further herein, the models may be dynamically updated during field operation. For initial training, a SoC designer may train these models on labeled datasets encompassing various protocols and interference scenarios.

In embodiments, the class probability information may include a probability distribution to identify the particular wireless protocols that have received signals and corresponding probability values, e.g., percentages or other weights to indicate a relative probability of these different wireless protocols, also referred to herein as so-called classes.

Still referring to FIG. 1, this class probability information is provided to a coexistence management controller 180. As shown in FIG. 1, coexistence management controller 180 includes an interference predictor 182, which may predict a likelihood of future interference between signals of these given classes (wireless protocols). In an embodiment, interference predictor 182 may be configured to continuously monitor spectrum occupancy and signal quality metrics (e.g., Signal-to-Noise Ratio, Bit Error Rate), and detect anomalies and patterns indicative of interference or congestion. In one or more embodiments, interference predictor 182 may execute one or more AI/ML models based on the class probability information to generate the interference prediction information. In an embodiment, interference predictor 182 may use reinforcement learning algorithms, such as Q-Learning or Deep Q-Networks (DQNs), to optimize coexistence strategies, and may consider one or more factors such as protocol priorities, Quality of Service (QoS) requirements, and/or historical performance data.

This interference prediction information is provided to a spectrum allocator 184, which may allocate spectrum resources based at least in part on the interference prediction information and provide the allocated spectrum, e.g., given wireless protocols and time information, to a scheduler 185. In an embodiment, scheduler 185 may be configured to perform grant signaling, implementing centralized or distributed grant signaling protocols (e.g., Request-to-Send/Clear-to-Send, Time Division Multiple Access) to issue grant signals with precise timing and duration to control medium access. Scheduler 185 may be configured to generate a schedule, e.g., time durations within a given scheduling interval for one or more of the wireless protocols to have access to the spectrum resources.

Still with reference to FIG. 1, this scheduling information is provided to a radio controller 195. Radio controller 195 is configured to control the various circuitry of transmit signal processing path 150 and receive signal processing path 110 according to the scheduling information to enable the appropriate transmission and reception of signals of the scheduled wireless protocols during the allocated time durations.

Finally, with further reference to FIG. 1, a feedback circuit 195 receives performance feedback information. Note that performance feedback information such as throughput, latency, packet loss and energy consumption may be received from various portions of transmit signal processing path 150 and/or receive signal processing path 110. Based at least in part on this performance feedback information, feedback circuit 190 may perform online updates to one or more AI/ML models that are used within signal identifier circuit 170 and/or coexistence management controller 180. Although shown at this high level in the embodiment of FIG. 1, many variations and alternatives are possible.

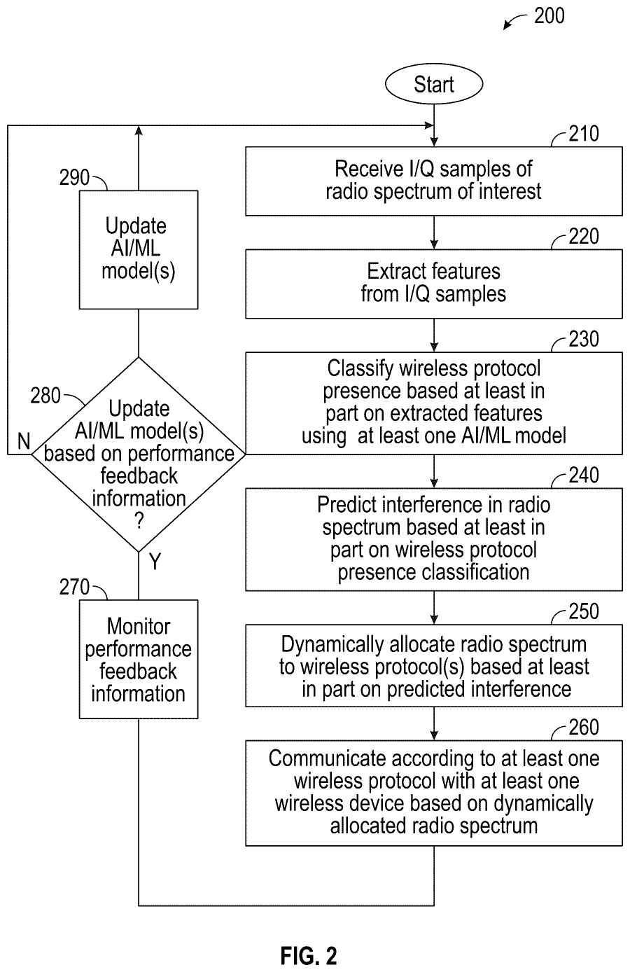

Referring now to FIG. 2, shown is a flow diagram of a method in accordance with an embodiment. More specifically, method 200 is a method for operating a wireless transceiver in accordance with an embodiment. As such, method 200 may be performed by hardware circuitry, e.g., of a multi-protocol wireless transceiver SoC alone and/or in combination with firmware and/or software.

As illustrated, method 200 begins by receiving I/Q samples of a radio spectrum of interest (block 210). For purposes of discussion assume that this radio spectrum of interest includes the 2.4 GHz band, which may be used by various wireless protocols, including Wi-Fi, Bluetooth, and/or IEEE 802.15.4 protocols, among others. At block 220, I/Q features may be extracted from the I/Q samples. As examples, such feature extraction may include the various analyses described herein.

Still referring to FIG. 2, at block 230 wireless protocol presence may be classified based at least in part on these extracted features. More specifically, in embodiments herein, at least one AI/ML model may be used to classify the wireless protocol presence. This classification may result in a probability distribution of one or more protocols that operate at a common band. Thereafter at block 240, interference within the radio spectrum may be predicted based at least in part on the wireless protocol presence classification. Note that this interference prediction also may be determined using one or more other AI/ML models.

With further reference to FIG. 2, at block 250 the radio spectrum may be dynamically allocated to one or more wireless protocols based at least in part on this predicted interference. Then at block 260, wireless communications may occur according to at least one active wireless protocol based on the dynamically allocated radio spectrum. For example, with an example for a 2.4 GHz band, based on the dynamic allocation, communication with a first wireless device may proceed according to a Wi-Fi communication protocol and then another communication with the same or possibly a different wireless device may proceed according to a given Bluetooth wireless protocol.

Still with reference to FIG. 2, at block 270 during this operation of the transceiver, performance feedback information may be monitored. Although embodiments are not limited in this regard, such performance feedback information may include one or more collected metrics such as metrics regarding throughput, latency, packet loss, and energy consumption, and/or anomaly detection information based on statistical-based detection of deviation from expected performance. Then at diamond 280, it may be determined whether to update one or more of the AI/ML models based on this performance feedback information. For example, if the performance feedback information indicates deviation from desired thresholds, parameters (e.g., weights of one or more neurons of a given AI/ML model) of one or more of the AI/ML models may be updated (block 290). In this way, online learning may be used to continuously update ML models, e.g., using techniques like stochastic gradient descent (SGD) and hyperparameter tuning in which learning rates may be adjusted, along with regularization parameters, and network architectures based on performance. Although shown at this high level in the embodiment of FIG. 2, many variations and alternatives are possible.

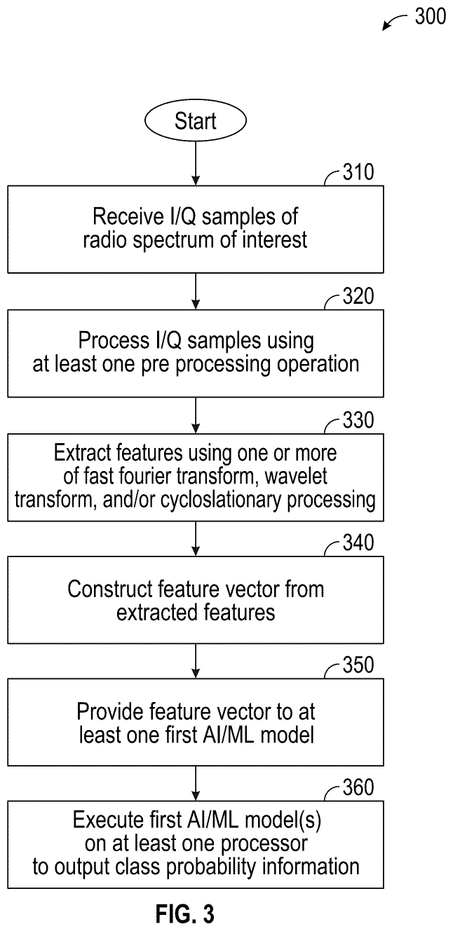

Referring now to FIG. 3, shown is a flow diagram of a method in accordance with another embodiment. More specifically, method 300 is a method for operating a wireless transceiver in accordance with another embodiment. As such, method 300 may be performed by hardware circuitry, e.g., of a multi-protocol wireless transceiver SoC alone and/or in combination with firmware and/or software.

As illustrated, method 300 begins by receiving I/Q samples of a radio spectrum of interest (block 310). At block 320, the I/Q samples may be processed using at least one preprocessing operation. Although embodiments are not limited in this regard, in one example preprocessing may include applying a low-pass filter to reduce noise and isolate signals within a desired frequency range. Thereafter at block 330, features may be extracted from these preprocessed samples. In the embodiment of FIG. 3, such feature extraction may use one or more of fast Fourier (FFT) transform, wavelet transform and/or cyclostationary processing. For example, a feature extraction engine may use FFT processing to convert time-domain signals into frequency-domain representations. In one implementation, the engine may be configured to break down incoming samples into N-point segments, and apply, e.g., a Cooley-Tukey FFT algorithm to compute a discrete Fourier transform (DFT), to identify dominant frequency components. The feature extraction engine may also perform wavelet transform processing to decompose samples into components at various scales. In one implementation, the engine may apply Continuous Wavelet Transform (CWT) or Discrete Wavelet Transform (DWT) using wavelet functions like Morlet or Daubechies, to capture transient features and time-frequency localization. The feature extraction engine may further perform a cyclostationary analysis to exploit periodicity in statistical properties of modulated signals. In an implementation, the engine may compute a Cyclic Autocorrelation Function (CAF), and calculate a Spectral Correlation Density (SCD), to distinguish signals based on their modulation schemes and symbol rates

Still referring to FIG. 3, next at block 340, a feature vector may be constructed from these extracted features. In one example, the feature extraction engine may construct a feature vector that combines features extracted from one or more of these FFT, Wavelet, and cyclostationary analyses into a feature vector, e.g., according to: X=[x₁, x₂, . . . , xₙ], where x₁₋ₙ are the set of extracted features. Next at block 350, this feature vector may be provided to at least one first AI/ML model. In an embodiment, these first AI/ML models may include CNNs or RNNs.

In an embodiment, a CNN may have an architecture including an input layer that accepts 2D representations of signal features (e.g., spectrograms), convolutional layers that apply convolutional filters to detect local patterns, pooling layers to reduce dimensionality using Max Pooling or Average Pooling, fully connected layers to aggregate features for classification, and an output layer that may use a Softmax activation for multi-class classification. In an embodiment, the CNN may operate as follows: perform a convolution operation using a FeatureMapᵢ=Convolution (Input, Filterᵢ)+Biasᵢ; perform an activation function that applies a ReLU (Rectified Linear Unit) activation: f(x)=max(0,x); perform pooling to reduce spatial dimensions; perform flattening to convert 2D feature maps to 1D feature vectors; and perform classification by computing class probabilities using

$$P ( y = j ) = \frac{{e}^{zj}}{{\sum }_{k} {e}^{zk}} .$$

In an embodiment, a RNN may have an architecture that incorporates Long Short-Term Memory (LSTM) units to capture temporal dependencies. In an embodiment, the RNN may perform LSTM cell computations according to Table 1 below.

TABLE 1

Forget Gate: fₜ = σ(W_{f} * [hₜ₋₁, xₜ] + b_{f})
Input Gate: iₜ = σ(Wᵢ * [hₜ₋₁, xₜ] + bᵢ)
Candidate Memory: \tilde{C}ₜ = tanh (W_{C} * [hₜ₋₁, xₜ] + b_{C})
Cell State Update: Cₜ = fₜ * Cₜ₋₁ + iₜ * \tilde{C}ₜ
Output Gate: Oₜ = σ(Wₒ * [hₜ₋₁, xₜ] + bₒ)
Hidden State Update: hₜ = oₜ * tanh (Cₜ)

Then, the RNN may perform sequence processing to process the feature vectors over time steps to capture temporal patterns. In turn, the RNN generates a classification output as a probability distribution over the possible signal classes (e.g., Zigbee, BLE, Wi-Fi). In an embodiment, the class with the highest probability is selected as the identified protocol.

Still with reference to FIG. 3, at block 360, the models may be executed on at least one processor to output class probability information. In a particular embodiment in which a wireless SoC includes one or more neural processing units (NPUs), these models may be executed on such neural processors. In other cases, other accelerators such as a vector processing unit may execute one or more of the models. At the conclusion of method 300, class probability information, e.g., in the form of a probability distribution, is generated.

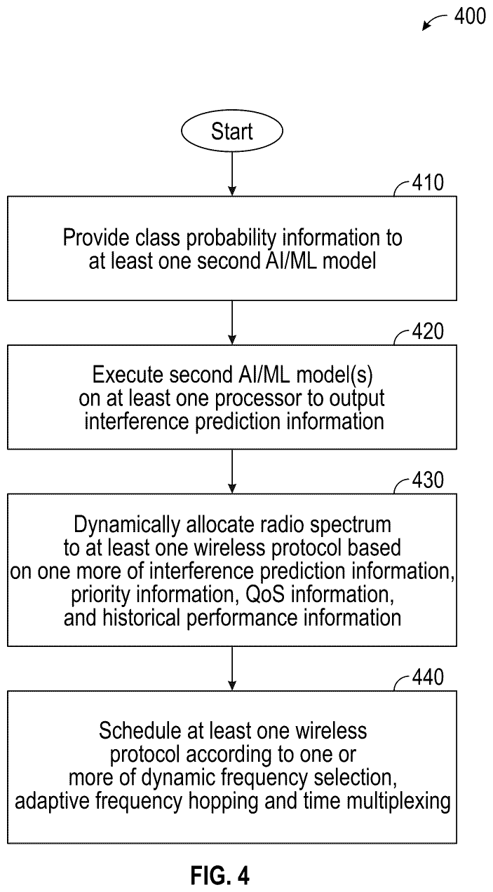

Referring now to FIG. 4, shown is a flow diagram of a method in accordance with yet another embodiment. More specifically, method 400 is a method for operating a wireless transceiver in accordance with another embodiment. As such, method 400 may be performed by hardware circuitry, e.g., of a multi-protocol wireless transceiver SoC alone and/or in combination with firmware and/or software.

As shown, method 400 begins by providing the class probability information (such as determined with regard to method 300 of FIG. 3) to at least one second AI/ML model (block 410). As examples, these second models may include a Deep Q-Network (DON) or an LTSM network.

A DON algorithm may be used for reinforcement learning, allowing the system to learn optimal spectrum allocation policies through exploration and exploitation of different actions. In an embodiment, a DON may have a State Space (SSS) that represents current network conditions, including spectrum occupancy, signal classifications, and interference metrics; an Acton Space (AAA) that indicates possible spectrum allocation and scheduling actions; and a Reward Function (RRR) that quantifies performance, e.g., increased throughput, reduced collisions. In an embodiment, a DQN may operate according Table

TABLE 2
Algorithm Steps:

| | |
|---|---|
| 1. | Initialize Replay Memory: |

Stores past experiences Sₜ, αₜ, rₜ, Sₜ₊₁

| | |
|---|---|
| 2. | Initialize Q-Network: |

A neural network approximates the Q-value function
Q(s, α, θ)

| | |
|---|---|
| 3. | Policy Selection (ε-greedy): |

Selects action aₜ based on the current state Sₜ:

With probability ϵ, select a random action.
Otherwise, select αₜ = arg max_{α} Q(Sₜ, α; θ).

| | |
|---|---|
| 4. | Execute Action and Observe Reward: |

Apply the selected action and observe the reward rₜ and
next state Sₜ + 1.

| | |
|---|---|
| 5. | Store Experience: |

Add (Sₜ, αₜ, rₜ, Sₜ₊ₜ) to the replay memory.

| | |
|---|---|
| 6. | Mini-Batch Training: |

Sample a random mini-batch from replay memory.
Compute the target Q-value:

Yᵢ = rᵢ + γ_{maxα}_{^{′}}Q(Sᵢ₊₁, α′; θ′)

Update network weights by minimizing the loss:

$L ( θ ) = \frac{1}{N} {\sum }_{i} {( {y}_{i} - Q ( {s}_{i} , {α}_{i} ; θ ) )}^{2}$

| | |
|---|---|
| 7. | Update Target Network: |
| | Periodically update the target network parameters θ′ ← θ. |
| 8. | Iterate: |
| | Repeat steps 3-7 for each time step. |

In an embodiment, predictive modeling may be performed using LSTM networks. In an embodiment, a LTSM network may operate according to Table 3.

TABLE 3
Used for time-series prediction of interference patterns.
Algorithm Steps:

| | |
|---|---|
| 1. | Input Sequence Preparation: |
| | Sequence of historical interference metrics [Iₜ₋ₙ, ..., Iₜ]. |
| 2. | LSTM Processing: |
| | Processes the sequence to predict future interference |
| | levels [Iₜ₋₁, ..., Iₜ₊ₘ] |
| 3. | Output Interpretation: |
| | Predicted interference levels inform the decision |
| | engine for proactive adjustments. |

Still with reference to FIG. 4, at block 420, such models may execute on at least one processor to determine interference prediction information. As discussed above, the models may execute on a NPU, vector processor or other accelerator of a wireless transceiver SoC. Then at block 430, the radio spectrum may be dynamically allocated to at least one wireless protocol. Such dynamic allocation may proceed based on one or more of the interference prediction information, priority information, quality of service (QoS) information, and historical performance information. For example, two wireless protocols can be allocated based on at least some of this information. As one example, a first wireless protocol may be selected for operation during a first time duration of a scheduling interval, and a second wireless protocol may be selected for operation during a second time duration of the scheduling interval. In a particular use case, the first time duration may be longer than the second time duration where the first wireless protocol is of a higher priority than the second wireless protocol. And further understand that the length of the allocated time durations and/or selected wireless protocols may dynamically change over time based on further analysis of the incoming RF spectrum, changes in priority, or so forth.

Finally at block 440, at least one wireless protocol may be scheduled access to the spectrum resources for at least a given time duration of a scheduling interval. In the embodiment of FIG. 4, such scheduling may be according to one or more of: dynamic frequency selection; adaptive frequency hopping; and time multiplexing.

In an embodiment, DFS may include: spectrum sensing to monitor channels for occupancy and interference levels; channel ranking to rank channels based on interference metrics and protocol requirements; and channel assignment to allocate channels to protocols based on rankings and QoS requirements. During operation, DFS may further be used to continuously monitor performance and reassign channels as needed. In an embodiment, adaptive frequency hopping may include hopping sequence generation in which pseudo-random sequences are generated, avoiding channels with high interference, and synchronization is achieved by ensuring that all devices in the network follow the same hopping sequence. During operation, hopping sequences may be dynamically adjusted based on real-time interference data. In an embodiment, Time Division Multiple Access (TDMA) includes time slot allocation in which time is divided into slots that are assigned to given protocols or devices. During operation, slot durations and assignments may be dynamically adjusted based on traffic demands and interference predictions. Network synchronization may be maintained to ensure proper timing.

In an embodiment, grant signaling may be performed using Request-to-Send/Clear-to-Send (RTS/CTS) signals. In such embodiment, RTS Frame Transmission occurs for a device to request medium access, and a controller responds with a CTS Frame Response to grant access. Then data transmission occurs in which the device transmits data within the granted time window. Collision avoidance is realized as other devices refrain from transmitting during the granted period.

In an embodiment, a scheduler may perform scheduling according to a Weighted Round Robin (WRR) algorithm, in which weights are assigned to protocols based on priorities, queues are maintained for each protocol, and these queues are served in a round-robin fashion proportionally to their weights. In another embodiment, a scheduler may perform scheduling according to a Deficit Round Robin (DRR) algorithm, in which each queue has a deficit counter that is initialized to zero, packets are served from each queue if the packet size is less than or equal to the deficit counter, then the deficit counters may be increased by a quantum value after each round.

By using AI/ML techniques as described herein, superior signal classification accuracy exceeding 99% may be realized. Embodiments may also provide adaptive interference mitigation by adapting to changing environments, learning from new interference patterns and network conditions. Optimized network performance (such as increased network throughput, reduced latency, and reduced collision rates) may be realized using intelligent scheduling and resource allocation in accordance with an embodiment. Embodiments may also realize energy efficiency as a result of reduced retransmissions and optimized transmission schedules. lead to energy savings of up to 20% for battery-powered devices.

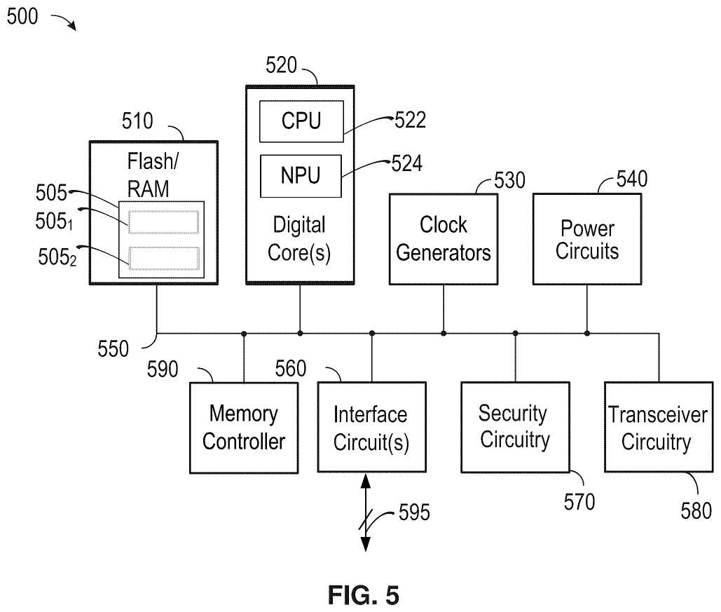

Referring now to FIG. 5, shown is a block diagram of a representative integrated circuit 500 that includes AI/ML circuitry to intelligently manage coexistence of multiple wireless protocols operating at a common frequency spectrum as described herein. In the embodiment shown in FIG. 5, integrated circuit 500 may be, e.g., a multi-mode wireless transceiver that may operate according to one or more wireless protocols or other device that can be used in a variety of use cases. In one or more embodiments, the circuitry of integrated circuit 500 shown in FIG. 5 may be implemented on a single semiconductor die or implemented on separate dies for wireless communication, MCU compute, external flash and/or other IP blocks needed to perform various functionalities.

Integrated circuit 500 may be included in a range of devices, but for purposes of discussion, it may be incorporated into an IoT device. In the embodiment shown, integrated circuit 500 includes a memory system 510 which in an embodiment may include volatile storage, such as RAM and non-volatile memory such as a flash memory. The flash memory is a non-transitory storage medium that can store instructions and data. Although embodiments are not limited in this regard, memory subsystem 510 may include on-chip flash memory for firmware and ML model storage, and SRAM for runtime data and intermediate computations.

In embodiments, memory subsystem 510 includes non-volatile storage 505, which may store firmware code 5051 for performing the intelligent coexistence management described herein, and a model storage 5052 for storing the various AI/ML models used described herein. Integrated circuit 500 also may include a memory controller 590.

Memory system 510 couples via a bus 550 to one or more digital cores 520, which may include one or more cores and/or microcontrollers that act as processing units of the integrated circuit, and which may execute all or portions of the intelligent coexistence management techniques described herein. In an embodiment, cores 520 may be implemented with a multi-core processor architecture of a central processing unit (CPU) 522, such as ARM Cortex-M33 cores with integrated TrustZone technology for enhanced security. Digital cores 520 may further include AI/ML hardware accelerators, such as one or more dedicated neural processing units (NPUs) 524 and/or digital signal processors (DSPs) optimized for ML inference tasks. Such accelerators may provide support for quantized neural networks and hardware-accelerated matrix computations. In turn, digital cores 520 may couple to clock generators 530 which may provide one or more phase locked loops or other clock generator circuitry to generate various clocks for use by circuitry of the IC.

As further illustrated, IC 500 further includes power circuitry 540. Additional circuitry may be present depending on particular implementation to provide various functionality and interaction with external devices. Such circuitry may include interface circuitry 560 which provides a digital communication interface with additional circuitry (such as another IC that can couple to IC 500 via a link 595). IC 500 also may include security circuitry 570 to perform wireless security techniques.

In addition, as shown in FIG. 5, transceiver circuitry 580 may be provided to enable transmission and reception of wireless signals, e.g., according to one or more of a local area or wide area wireless communication scheme, such as Matter, Zigbee, Bluetooth, IEEE 802.11, IEEE 802.15.4, cellular communication or so forth. Understand while shown with this high level view, many variations and alternatives are possible.

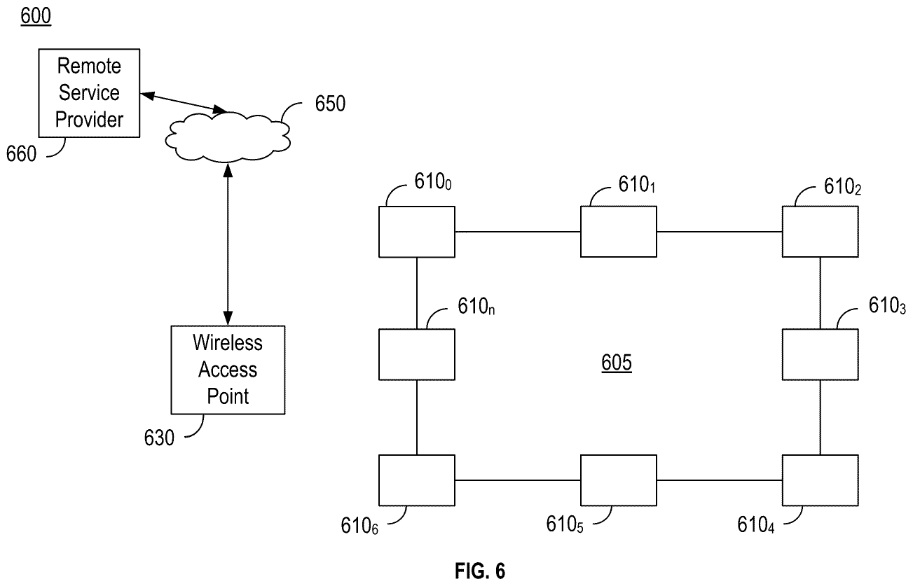

ICs such as described herein may be implemented in a variety of different devices as described above. Referring now to FIG. 6, shown is a high level diagram of a network in accordance with an embodiment. As shown in FIG. 6, a network 600 includes a variety of devices, including IoT devices that may intelligently mitigate interference between multiple wireless protocols operating within a common radio spectrum as described herein. Understand that network 600 includes other devices such as access points and remote service providers.

In the embodiment of FIG. 6, a wireless mesh network 605 is present, e.g., in a building having multiple wireless devices 610o-n. As shown, wireless devices 610, which may be IoT or other wireless devices, couple to an access point 630 that in turn communicates with a remote service provider 660 via a wide area network 650, e.g., the Internet. Understand while shown at this high level in the embodiment of FIG. 6, many variations and alternatives are possible.

For example, embodiments may be used in many different use cases, such as smart city networks to manage dense wireless networks in urban environments with high device density. Another use case may be in connection with automotive communications to ensure reliable wireless communication in connected vehicles and transportation systems. A still further use case may be for industrial automation facilities, to enable robust communication among sensors, actuators, and control systems in such settings. A yet further example use case may be in connection with healthcare facilities to support interference-free operation of medical devices and patient monitoring systems. Of course, many other use cases may leverage the embodiments described herein.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. An apparatus comprising:
a wireless transceiver to communicate radio frequency (RF) signals of a plurality of wireless protocols;
a signal identifier circuit coupled to the wireless transceiver, the signal identifier circuit to:
collect signal data from incoming RF signals of a portion of a radio spectrum received via the wireless transceiver;
extract a plurality of features from the signal data; and
identify a presence of signaling of at least one wireless protocol in the incoming RF signals, based at least in part on the plurality of features, using at least one first artificial intelligence (AI) model; and
a coexistence management controller coupled to the signal identifier circuit, the coexistence management controller to:
predict, based at least in part on the presence of signaling, interference in the portion of the radio spectrum using at least one second AI model; and
dynamically allocate spectrum resources of the portion of the radio spectrum based at least in part on the interference prediction.

2. The apparatus of claim 1, wherein the coexistence management controller comprises a scheduler to generate scheduling information according to the dynamically allocated spectrum resources, the scheduling information to identify one or more wireless protocols to be active during a scheduling interval.

3. The apparatus of claim 2, wherein the scheduler is to issue at least one grant signal for the one or more wireless protocols to a media access control layer of the wireless transceiver to cause the one or more wireless protocols to be active during the scheduling interval.

4. The apparatus of claim 2, further comprising a feedback circuit to receive feedback information regarding performance of the one or more wireless protocols, and to update the at least one second AI model based at least in part on the feedback information.

5. The apparatus of claim 1, wherein the at least one first AI model comprises at least one of a convolutional neural network (CNN) or a recurrent neural network (RNN), and the at least one second AI model comprises a reinforcement learning algorithm.

6. The apparatus of claim 1, wherein the signal identifier circuit is to identify the presence of signaling comprising a probability distribution regarding a plurality of wireless protocols that operate at the portion of the radio spectrum comprising a common portion of the radio spectrum.

7. The apparatus of claim 6, wherein the coexistence management controller is to predict the interference based at least in part on the probability distribution, the probability distribution comprising a plurality of probability values, each associated with one of the plurality of wireless protocols.

8. The apparatus of claim 1, wherein the signal identifier circuit is to extract the plurality of features using at least one of a Fast Fourier Transform, a Wavelet Transform, or a cyclostationary analysis.

9. The apparatus of claim 8, wherein the signal identifier circuit is to:
generate at least one feature vector based at least in part on the plurality of features extracted using at least two of the Fast Fourier Transform, the Wavelet Transform, or the cyclostationary analysis; and
provide the at least one feature vector to the at least one first AI model to identify the presence of signaling.

10. The apparatus of claim 1, wherein the coexistence management controller is to dynamically allocate the spectrum resources of the portion of the radio spectrum further based at least in part on priority information associated with one or more of the plurality of wireless protocols.

11. The apparatus of claim 1, wherein the apparatus comprises a system on chip comprising:
the wireless transceiver;
at least one host processor to execute instructions; and
at least one neural processor to run the at least one first AI model and the at least one second AI model.

12. A method comprising:
receiving, in a wireless transceiver of a wireless device, incoming radio frequency (RF) signals of a plurality of wireless protocols, the plurality of wireless protocols to communicate in a common band;
extracting a feature set from the incoming RF signals using a plurality of feature extraction techniques;
classifying, in the wireless device, the incoming RF signals, based at least in part on the feature set, using at least one first artificial intelligence (AI) model, to determine a probability distribution regarding the plurality of wireless protocols;
predicting an interference scenario based at least in part on the probability distribution, using at least one second AI model; and
dynamically allocating the common band to at least one of the plurality of wireless protocols based at least in part on the interference scenario.

13. The method of claim 12, wherein dynamically allocating the common band to the at least one of the plurality of wireless protocols comprises scheduling a first wireless protocol to operate on the wireless transceiver for a first time duration of an interval and scheduling a second wireless protocol to operate on the wireless transceiver for a second time duration of the interval, the first time duration longer than the second time duration.

14. The method of claim 13, further comprising scheduling the first wireless protocol and the second wireless protocol further based at least in part on a first priority associated with the first wireless protocol and a second priority associated with the second wireless protocol, the first priority higher than the second priority.

15. The method of claim 14, further comprising in response to a change in at least the second priority, scheduling the second wireless protocol to operate for a third time duration, the third time duration longer than the second time duration.

16. The method of claim 12, further comprising classifying the incoming RF signals on at least one neural processor of the wireless device, using the at least one first AI model.

17. A computer-readable storage medium comprising instructions that when executed by at least one processor of a wireless device cause the wireless device to perform a method comprising:
receiving, in at least one processor of a wireless transceiver, class probability information comprising a probability distribution regarding activity of a plurality of wireless protocols in a common band of a radio spectrum;
predicting an interference scenario based at least in part on the class probability information using at least one artificial intelligence (AI) model; and
dynamically allocating the common band to at least one of the plurality of wireless protocols based at least in part on the interference scenario.

18. The computer-readable storage medium of claim 17, wherein dynamically allocating the common band to the at least one of the plurality of wireless protocols comprises scheduling a first wireless protocol to operate on the wireless transceiver for a first time duration of an interval and scheduling a second wireless protocol to operate on the wireless transceiver for a second time duration of the interval, the first time duration different than the second time duration.

19. The computer-readable storage medium of claim 18, wherein the method further comprises scheduling the first wireless protocol for the first time duration and scheduling the second wireless protocol for the second time duration further based at least in part on a first priority of the first wireless protocol and a second priority of the second wireless protocol.

20. The computer-readable storage medium of claim 18, wherein the method further comprises:
receiving feedback information regarding performance of the first wireless protocol and the second wireless protocol; and
updating the at least one AI model based at least in part on the feedback information.
